(19) United States
(12) Patent Application Publication
(10) Pub. No.: US 2025/0042277 A1
(43) Pub. Date: Feb. 6, 2025

(54) Cover Device

(71) Applicant: Illinois Tool Works Inc., Glenview, IL (US)

(72) Inventor: Yuan SUN, Shanghai (CN)

(21) Appl. No.: 18/790,288

(22) Filed: Jul. 31, 2024

(30) Foreign Application Priority Data
Aug. 3, 2023 (CN) 202310978627.3
Jul. 25, 2024 (CN) 202411008920.8

(51) Int. Cl. B60L 53/16

(52) U.S. Cl. CPC B60L 53/16

(57) ABSTRACT

The present disclosure relates to the technical field of vehicle components, and in particular to a cover device, which is flippable between a first shielding position and a second shielding position, the cover device comprising: a housing and a flip trigger device. The flip trigger device is at least partially accommodated in the housing and having a first side and a second side disposed oppositely. The flip trigger device is configured to generate a flip trigger signal after the first side and the second side are respectively stressed by force, such that the housing is driven to flip between the first shielding position and the second shielding position. In the present disclosure, the protective cover assembly can be flipped between two charging openings by means of only one cover device, which reduces the cost of the protective cover assembly while achieving the function of charging through one of the charging ports and shielding the other charging port.

### RELATED APPLICATIONS

The present application claims the benefit of Chinese Patent Application Nos. 202310978627.3, filed Aug. 3, 2023, and 202411008920.8, filed Jul. 25, 2024, each titled “Cover Device,” the contents of which are hereby incorporated by reference.

### TECHNICAL FIELD

The present disclosure relates to the technical field of vehicle components, and in particular to a cover device for a vehicle charging port.

### BACKGROUND

With the transition from traditional energy to new energy, electric vehicles have become increasingly popular. Unlike traditional internal combustion engine vehicles that need to be refueled, the electric vehicles need to be charged during use. The electric vehicles are generally charged by two methods, i.e., AC charging (commonly known as “slow charging”) and DC charging (commonly known as “fast charging”). In order to achieve the above two charging methods, the electric vehicle needs to be provided with both an AC charging port and DC charging port respectively matching the charging methods. In some electric vehicles, the AC charging port and the DC charging port are respectively disposed at different positions of the vehicle body; and in some electric vehicles, the AC charging port and the DC charging port are disposed at adjacent positions, which is convenient for users to use. Similar to a fuel filler cap of a fuel vehicle, the charging port of the electric vehicle is generally shielded by a charging port cover, and the charging port cover is opened before charging to expose the AC charging port or the DC charging port. In order to protect the charging port from interference from rain, dust, etc. and prevent the entry of foreign objects, separate protective covers are usually provided on the AC charging port and the DC charging port, respectively, and users can selectively open the protective cover on the AC charging port or the protective cover on the DC charging port so as to allow a charging gun to be inserted into the corresponding charging port. In order to facilitate user operation and to better protect the charging port, there is a need for an improved technical solution for the charging port protective cover mentioned above.

### SUMMARY

The present disclosure relates generally to a protective cover assembly, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a schematic diagram of a structure of a protective assembly 100 for a vehicle charging socket according to the present disclosure.

FIG. 2A is a schematic diagram of a cover device 120 according to the present disclosure in a first shielding position.

FIG. 2B is a schematic diagram of cover device according to the present disclosure in a second shielding position.

FIG. 3 is a schematic exploded view of an internal structure of the cover device shown in FIG. 2A.

FIG. 4A is a schematic diagram of a front structure of a first side actuating portion 330 shown in FIG. 3.

FIG. 4B is a schematic diagram of a back structure of the first side actuating portion 330 shown in FIG. 3.

FIG. 5A is a schematic diagram of a back structure of an upper housing 301 shown in FIG. 3.

FIG. 5B is a schematic diagram of a structure of the first side actuating portion 330 shown in FIG. 3 mounted into the upper housing 301.

FIG. 6A is a schematic diagram of a front structure of a mounting bracket 340 shown in FIG. 3.

FIG. 6B is a schematic diagram of a back structure of the mounting bracket 340 shown in FIG. 3.

FIG. 7A is a schematic diagram of a back structure of a lower housing 302 shown in FIG. 3.

FIG. 7B is a schematic diagram of a structure of the mounting bracket 340 shown in FIG. 3 mounted into the lower housing 302.

FIG. 8A is a schematic diagram of a structure of the cover device 120 shown in FIG. 2A.

FIG. 8B is a cross-sectional view of the cover device 120 shown in FIG. 8A.

FIG. 9A is a schematic diagram of a structure of the cover device 120 shown in FIG. 2B.

FIG. 9B is a cross-sectional view of the cover device 120 shown in FIG. 9A.

FIG. 10 is a schematic diagram of the cover device 120 according to the present disclosure mounted to a pivot assembly 400.

FIG. 11 is a schematic diagram of a structure of a signal processing unit 500 of a vehicle according to the present disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

In the present disclosure, the protective cover assembly can be flipped between two charging openings by means of only one cover device, which reduces the cost of the protective cover assembly while achieving the function of charging through one of the charging ports and shielding the other charging port.

According to one aspect of the present disclosure, a cover device is provided. The cover device includes: a housing; a flip trigger device, the flip trigger device being at least partially accommodated in the housing and having a first side and a second side disposed oppositely, the flip trigger device is configured to generate a flip trigger signal after the first side and the second side are respectively stressed by force, such that the housing is driven to flip between the first shielding position and the second shielding position; wherein the flip trigger device is configured to remain stationary relative to the housing and be actuated to generate the flip trigger signal when the flip trigger device is stressed by force in a direction from the first side to the second side, and to be movable relative to the housing and be actuated to generate the flip trigger signal when the flip trigger device is stressed by force in a direction from the second side to the first side.

According to one aspect of the present disclosure, the flip trigger device comprises a trigger portion disposed on the first side, the trigger portion is configured to: be actuated by pressing, when the first side of the flip trigger device is stressed by force, to generate the flip trigger signal; and move relative to the housing and be actuated by being abutted against, when the second side of the flip trigger device is stressed by force, to generate the flip trigger signal.

According to one aspect of the present disclosure, the cover device further comprises a first side actuating portion, the first side actuating portion is securely connected to the housing and comprises a biasable first side pressing portion, the first side pressing portion being biasable by pressing in the direction from the first side to the second side to contact the trigger portion.

According to one aspect of the present disclosure, the first side actuating portion further comprises a first groove portion, a first groove portion sealing member being provided in the first groove portion.

According to one aspect of the present disclosure, the first groove portion (201.3) is a U-groove or an O-groove.

According to one aspect of the present disclosure, the cover device further comprises a mounting bracket, the mounting bracket being securely connected to the housing and comprises: a biasable second side pressing portion, the second side pressing portion being biasable by pressing in the direction from the second side to the first side; and positioning snap-fitting portions for mounting the flip trigger device, the positioning snap-fitting portions being configured to securely mount the second side pressing portion onto the second side pressing portion, such that the second side pressing portion abuts against the second side of the flip trigger device.

According to one aspect of the present disclosure, the mounting bracket further comprises a second groove portion, a second groove portion sealing member being provided in the second groove portion.

According to one aspect of the present disclosure, the second groove portion is a U-groove or an O-groove.

According to one aspect of the present disclosure, the housing comprises a first mounting portion for mounting the first side actuating portion, an outer side of the first mounting portion comprises a first sealing member disposed around an edge of the first mounting portion, and a central portion of the first mounting portion is provided with a first opening, the first side pressing portion of the first side actuating portion being accessible from the outside of the housing via the first opening.

According to one aspect of the present disclosure, the housing comprises a second mounting portion for mounting the mounting bracket, an outer side of the second mounting portion comprises a second sealing member disposed around an edge of the second mounting portion, and a central portion of the second mounting portion is provided with a second opening, the second side pressing portion of the mounting bracket being accessible from the outside of the housing via the second opening.

According to one aspect of the present disclosure, the flip trigger device further comprises: a signal transmission portion, the signal transmission portion being configured to transfer the flip trigger signal generated by the trigger portion to a signal processing unit of a vehicle; and connecting portions, the connecting portions being configured to fit with the positioning portions in the second side pressing portion so as to connect the flip trigger device to the second side pressing portion.

According to another aspect of the present disclosure, a protective assembly for a vehicle charging port is provided. The protective assembly comprising: a shell mounted on a vehicle body, the shell comprising a first hole and a second hole disposed adjacently; a cover device; and a cover mounting portion, the cover device being mounted to the shell via the cover mounting portion in a flippable manner; wherein the cover device is configured to be flipped between a first shielding position in which the first hole is shielded and a second shielding position in which the second hole is shielded.

Some of the additional aspects and advantages of the present disclosure will be set forth in the following description, and some will become apparent from the following description, or be learned by practice of the present disclosure.

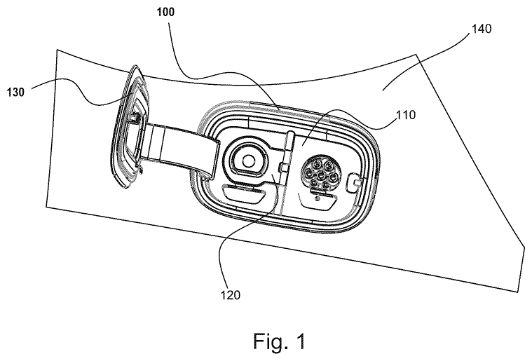

FIG. 1 is a schematic diagram of a structure of a protective assembly 100 for a vehicle charging socket according to the present disclosure.

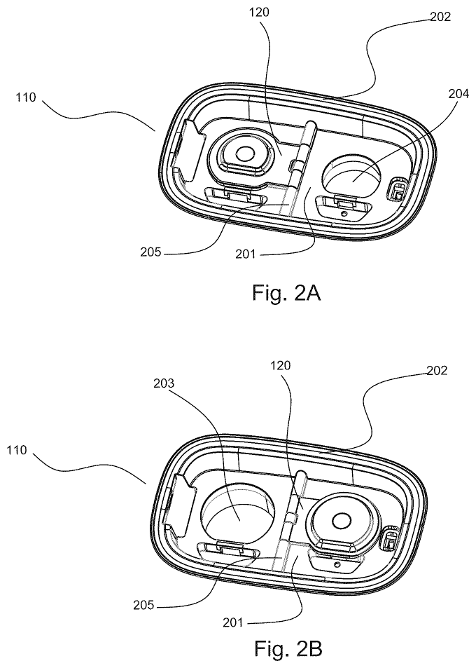

As shown in FIG. 1, the protective assembly 100 for a vehicle charging socket is mounted in place on a vehicle body 140. The charging socket protective assembly 100 includes a shell 110, a cover device 120, and a charging port cover 130. It should be noted that the charging socket protective assembly 100 further includes other assembly structures, which are omitted herein for ease of description. As shown in FIG. 1, the shell 110 is a concave structural member configured to be embedded in and mounted to the surface of the vehicle body 140, and the structure of the housing is described in detail below in FIG. 2A. The cover device 120 is mounted at the center of a base of the shell 110 in a flippable manner, and the charging port cover 130 is connected to the vehicle body 140 of the vehicle by means of a hinge or other structures. When the vehicle does not need to be charged, the charging port cover 130 is in a closed position, and then the outer surface of the charging port cover 130 is in the same plane as the surface of the vehicle body 140. When the vehicle needs to be charged, the controller in the vehicle controls the charging port cover 130 to open to an open position as shown in FIG. 1 so as to expose the vehicle charging socket, such that a user can insert a charging gun into the corresponding charging socket to charge the vehicle. It should be noted that the user may also open the charging port cover 130 by, for example, pressing.

FIGS. 2A and 2B are schematic diagrams of the cover device 120 according to the present disclosure respectively in a first shielding position and in a second shielding position.

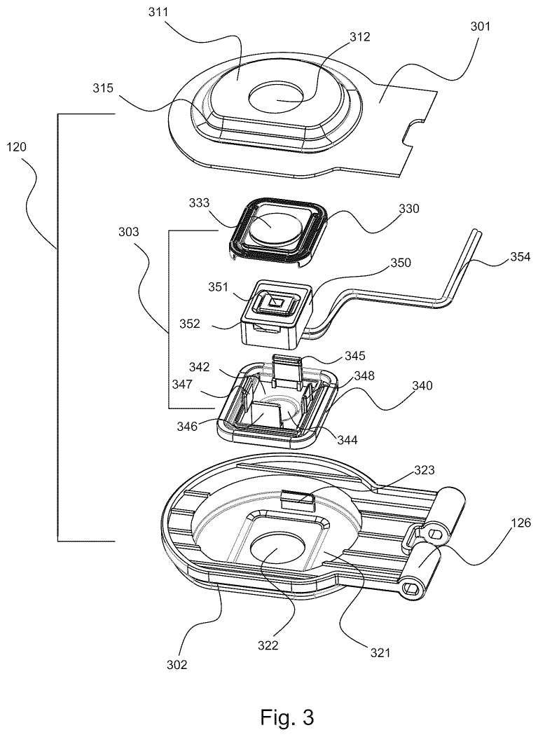

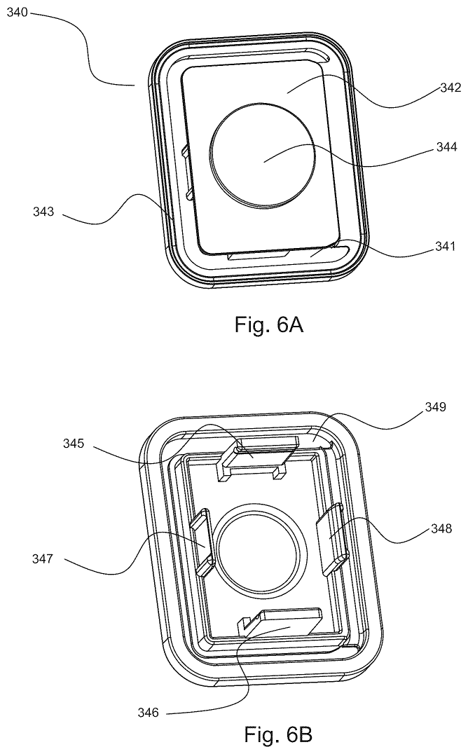

As shown in FIGS. 2A and 2B, according to an aspect of the present disclosure, the shell 110 has a concave structure, including a bottom portion 201, a peripheral rim 202, and a side wall portion connecting the bottom portion 201 and the peripheral rim 202. The peripheral rim 202 is sized slightly larger than the edge of the bottom portion 201, such that when the shell 110 is mounted to the vehicle body, the bottom portion 201 can pass through an opening of the corresponding size in the vehicle body, and the peripheral rim 202 can abut against the edge of the opening of the corresponding size in the vehicle body. The bottom portion 201 of the shell 110 is provided with two adjacent holes 203, 204 for respectively accommodating a DC charging socket and an AC charging socket (not shown) of the vehicle. The bottom portion 201 of the shell 110 is provided at the center a cover device mounting portion 205 for mounting the cover device 120 and a pivot shaft 400 (shown in FIG. 6), and the cover device 120 is mounted into the mounting portion 205 by means of a rotating shaft mounting portion 126 (shown in FIG. 3A) and is thus flippable around the mounting portion 205. As shown in FIG. 2A, the cover device 120 is in the first shielding position in which the first hole 203 is shielded, and at this time the DC charging socket mounted in the first hole 203 is shielded, and the AC charging socket mounted in the second hole 204 is exposed to the user, such that the user can insert an AC charging gun into the AC charging socket in the second hole 204, so as to achieve AC charging for the vehicle. As shown in FIG. 2B, the cover device 120 is in the second shielding position in which the second hole 204 is shielded, and at this time the AC charging socket mounted in the second hole 204 is shielded, and the DC charging socket mounted in the first hole 203 is exposed to the user, such that the user can insert a DC charging gun into the DC charging socket in the first hole 203, so as to achieve DC charging for the vehicle. The cover device 120 according to the present disclosure ensures that during charging for the vehicle only one charging socket is connected to the charging gun, and the other charging socket always remains in a closed state, thereby improving the safety during charging. Those skilled in the art should understand that the DC charging socket and the AC charging socket of the vehicle can be mounted into the first hole 203 or the second hole 204 according to actual needs, which is not limited to the lateral side-by-side arrangement in this aspect, and the first hole 203 or the second hole 204 may also be in a longitudinally side-by-side arrangement or in other readily conceivable arrangements according to actual needs.

FIG. 3 is schematic exploded view of an internal structure of the cover device 120 shown in FIG. 2A.

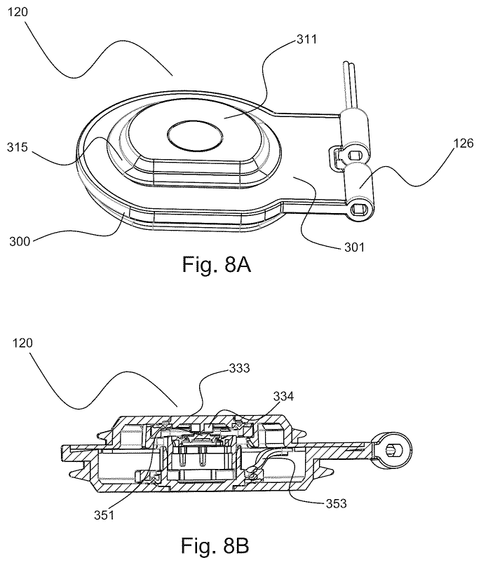

As shown in FIG. 3, the cover device 120 is in the first shielding position in which the first hole 203 is shielded as shown in FIG. 2A. As shown in FIG. 3 and the following FIGS. 8A and 8B, the cover device 120 includes a housing 300 and a press trigger device 303. The housing 300 includes an upper housing 301 and a lower housing 302, and the press trigger device 303 is disposed between the upper housing 301 and the lower housing 302. Those skilled in the art should understand that the upper housing and the lower housing are named only on the basis of the different position states shown in FIG. 3, and do not mean that the upper housing must be located above the lower housing.

As shown in FIG. 3, the upper housing 301 includes an irregular oval portion and a substantially rectangular portion extending outward from the irregular oval portion. The center of the irregular oval portion has a first mounting portion 311 that is shaped to match the irregular oval portion, the first mounting portion 311 is provided with a first opening 312 at the central position, the first mounting portion 311 has a contour that is shaped to fit with the second hole 204 shown in FIG. 2A, and is configured to shield the second hole 204 when the cover device 120 is in the second shielding position shown in FIG. 2B. Those skilled in the art should understand that the shape of the upper housing 301 may be designed according to actual needs, as long as it can achieve the function of shielding the second hole.

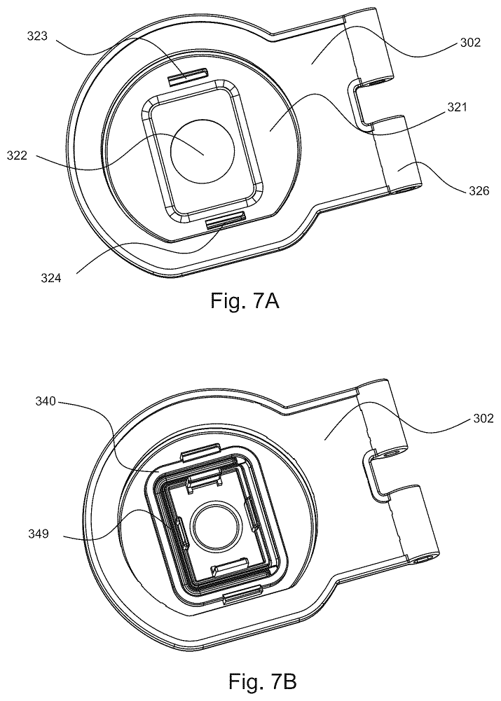

Accordingly, the lower housing 302 includes an irregular oval portion and a substantially rectangular portion extending outward from the irregular oval portion. The center of the irregular oval portion has a second mounting portion 321 that is shaped to match the irregular oval portion, the second mounting portion 321 is provided with an opening 322 at the central position, the second mounting portion 321 has a contour that is shaped to fit with the first hole 203 shown in FIG. 2B, and is configured to shield the first hole 203 when the cover device 120 is in the first shielding position shown in FIG. 2A. A cavity is formed inside the conical second mounting portion 321, and lower fixing portions (a pair of second fixing portions 323, 324 as shown) are disposed oppositely in the cavity for mounting the press trigger device 303. The end of the substantially rectangular portion extending outward from the irregular oval portion is provided with a rotating shaft mounting portion 326 as shown in FIGS. 7A and 7B, and the rotating shaft mounting portion 326 is configured to be mounted to a mounting portion 205 at the center of the bottom portion 201 of the shell 110 as shown in FIGS. 2A and 2B, such that the cover device 120 is fixed to the shell 110 in a flippable manner. Those skilled in the art should understand that the shape of the lower housing 302 may be designed according to actual needs, as long as it can achieve the function of shielding the first hole 203.

As shown in FIG. 3, the press trigger device 303 disposed between the upper housing 301 and the lower housing 302 includes a first side actuating portion 330, a mounting bracket 340, and a flip trigger device 350 located between the first side actuating portion 330 and the mounting bracket 340. Those skilled in the art should understand that the first side actuating portion 330 and the mounting bracket 340 are named only on the basis of the different position states shown in FIG. 3. The specific structure of the first side actuating portion 330 and the mounting bracket 340 is described with reference to the following drawings.

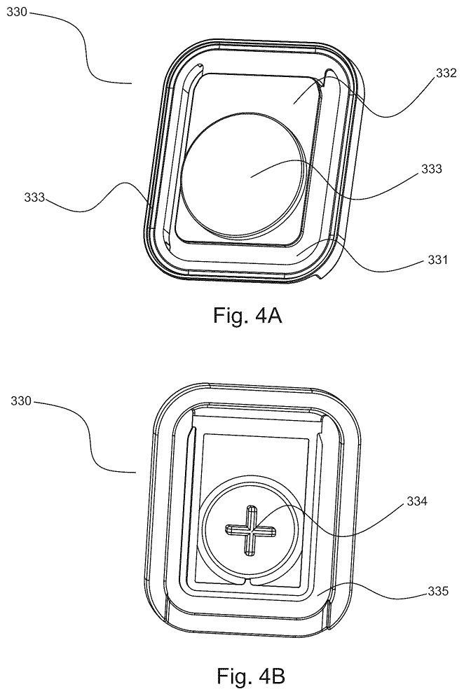

FIGS. 4A and 4B are schematic diagrams of front and back structures of the first side actuating portion 330 shown in FIG. 3.

As shown in FIG. 4A, in an aspect, the first side actuating portion 330 is of a square structure, and a U-shaped first groove portion 331 is provided along three edges of the square structure, such that a first side pressing portion 332 is formed in the first side actuating portion 330. The first side actuating portion 330 is provided with an upper sealing ring 343 along the frame thereof, so as to achieve waterproof sealing between the upper housing 301 and the first side actuating portion 330 when the first side actuating portion 330 is mounted into the upper housing 301. In this aspect, the first side pressing portion 332 is of a cantilever structure, one end of which is fixedly connected to the frame of the first side actuating portion 330, and the remaining portion is not connected to the frame of the first side actuating portion 330. In this way, when the first side pressing portion 332 is pressed, one end thereof fixedly connected to the frame of the first side actuating portion 330 remains stationary, and the movable end opposite to this end can move a distance relative to the first side actuating portion 330. As shown in FIGS. 4A and 4B, the surface of one side of the first side pressing portion 332 is provided with a first contact 333 for receiving pressure from the user's finger, and the surface of the other side of the first side pressing portion 332 is provided with a cross-shaped protrusion 334 at a position corresponding to the contact 333 for abutting against the flip trigger device 350 when the user presses the first side pressing portion 332. A U-shaped first groove portion sealing member 335 is provided in the U-shaped first groove portion 331, and the U-shaped first groove portion sealing member 335 is an elastic member, which enables the movable end of the first side pressing portion 332 to move a distance relative to the frame of the first side actuating portion 330 and also ensures that the first side pressing portion 332 can remain sealed relative to the frame of the first side actuating portion 330.

In another aspect, the first side actuating portion 330 is of a square structure, and is provided with an O-shaped first groove portion 331 along four edges of the square structure, such that a first side pressing portion 332 that is completely disconnected to the frame of the first side actuating portion 330, and the first side pressing portion 332 is connected to the frame of the first side actuating portion 330 by means of the O-shaped first groove portion sealing member 335 mounted in the O-shaped first groove portion 331. The O-shaped first groove portion sealing member 335 is an elastic member, which enables the first side pressing portion 332 to move a distance as a whole relative to the frame of the first side actuating portion 330 and also ensures that the first side pressing portion 332 can remain sealed relative to the frame of the first side actuating portion 330. Those skilled in the art should understand that the first side pressing portion 332 may also be disposed in the first side actuating portion 330 in other forms according to actual needs.

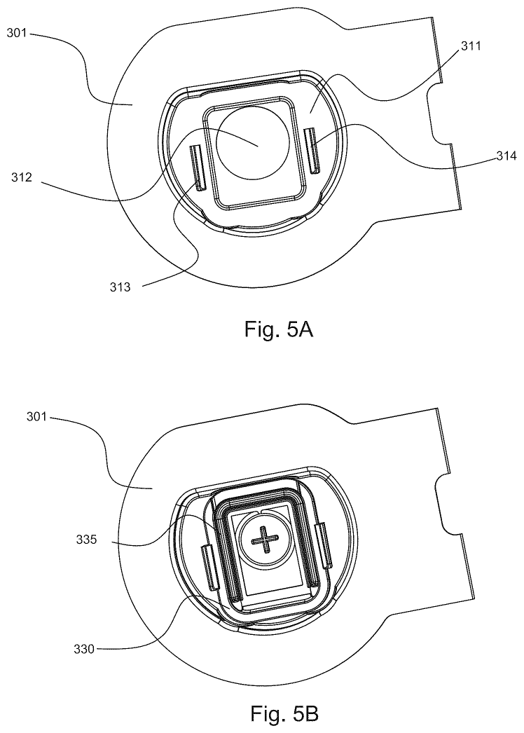

FIG. 5A is a schematic diagram of a back structure of an upper housing 301 shown in FIG. 3, and FIG. 5B is a schematic diagram of a structure of the first side actuating portion 330 shown in FIG. 3 mounted into the upper housing 301.

As shown in FIG. 5A, the upper housing 301 includes a first mounting portion 311 for accommodating the first side actuating portion 330, upper fixing portions (a pair of first fixing portions 313, 314 in this aspect) that are configured to fixedly mount the first side actuating portion 330 to the first mounting portion 311 are provided on the inner side of the first mounting portion 311, and the central portion of the first mounting portion 311 is provided with a first opening 312. As shown in FIG. 5B, when the first side actuating portion 330 is mounted into the upper housing 301, the upper fixing portions (the pair of first fixing portions 313, 314 in this aspect) in the first mounting portion 311 are respectively snap-fitted onto two side frames of the first side actuating portion 330, and the first contact 333 on the first side actuating portion 330 is located exactly in the opening 312 in the central portion of the first mounting portion 311. Those skilled in the art should understand that the first side actuating portion 330 may also be mounted into the upper housing 301 in other forms, such as by means of bonding or welding, according to actual needs.

FIGS. 6A and 6B are schematic diagrams of front and back structures of the mounting bracket 340 shown in FIG. 3.

As shown in FIG. 6A, in an aspect, the mounting bracket 340 is of a square structure and is provided with a U-shaped second groove portion 341 along three edges of the square structure, such that a second side pressing portion 342 is formed in the mounting bracket 340. The mounting bracket 340 is provided with a lower sealing ring 343 along the frame thereof, so as to achieve waterproof sealing between the lower housing 302 and the mounting bracket 340 when the mounting bracket 340 is mounted in the lower housing 302. In this aspect, the second side pressing portion 342 is of a cantilever structure, one end of which is fixedly connected to the frame of the mounting bracket 340, and the remaining portion is not connected to the frame of the mounting bracket 340. In this way, when the second side pressing portion 342 is pressed, one end thereof fixedly connected to the frame of the mounting bracket 340 remains stationary, and the movable end opposite to this end can move a distance relative to the mounting bracket 340. As shown in FIGS. 6A and 6B, the surface of one side of the second side pressing portion 342 is provided with a second contact 344 for receiving pressure from the user's finger, and the surface of the other side of the second side pressing portion 342 is provided with positioning portions 345, 346, 347, 348 along the frame thereof. When the flip trigger device 350 is mounted into the mounting bracket 340, the flip trigger device 350 is positioned by means of the positioning portions 345, 346, 347, 348, and at the same time the positioning portions 345, 346 are respectively fitted with two connecting portions (flanges) 352, 353 (as shown in FIG. 3) on the flip trigger device 350, such that the flip trigger device 350 is fixed into the second side pressing portion 342. A U-shaped second groove portion sealing member 349 is provided in the U-shaped second groove portion 341, and the U-shaped second groove portion sealing member 349 is an elastic member, which enables the movable end of the second side pressing portion 342 to move a distance relative to the frame of the mounting bracket 340 and also ensures that the second side pressing portion 342 can remain sealed relative to the frame of the mounting bracket 340.

In another aspect, the mounting bracket 340 is of a square structure and is provided with an O-shaped second groove portion 341 along four edges of the square structure, such that a second side pressing portion 342 that is completely disconnected to the frame of the mounting bracket 340, and the second side pressing portion 342 is connected to the frame of the mounting bracket 340 by means of the O-shaped second groove portion sealing member 349 mounted in the O-shaped second groove portion 341. The O-shaped second groove portion sealing member 349 is an elastic member, which enables the second side pressing portion 342 to move a distance as a whole relative to the frame of the mounting bracket 340 and also ensures that the second side pressing portion 342 can remain sealed relative to the frame of the mounting bracket 340. Those skilled in the art should understand that the second side pressing portion 342 may also be disposed in the mounting bracket 340 in other forms according to actual needs.

FIG. 7A is a schematic diagram of a back structure of a lower housing 302 shown in FIG. 3, and FIG. 7B is a schematic diagram of a structure of the mounting bracket 340 shown in FIG. 3 mounted into the lower housing 302.

As shown in FIG. 7A, the lower housing 302 includes a second mounting portion 321 for accommodating the mounting bracket 340, a pair of second fixing portions 323, 324 that are configured to fixedly mount the mounting bracket 340 into the lower mounting portion 321 are provided on an inner side of the second mounting portion 321, and the central portion of the second mounting portion 321 is provided with a second opening 322. As shown in FIG. 7B, when the mounting bracket 340 is mounted into the lower housing 302, the pair of second fixing portions 323, 324 in the mounting portion 321 are respectively snap-fitted onto two side frames of the mounting bracket 340, and the second contact 344 on the mounting bracket 340 is located exactly in the opening 322 in the central portion of the second mounting portion 321. Those skilled in the art should understand that the mounting bracket 340 may also be mounted into the lower housing 302 in other forms, such as by means of bonding or welding, according to actual needs.

FIG. 8A is a schematic diagram of a structure of the cover device 120 shown in FIG. 2A, and FIG. 8B is a cross-sectional view of the cover device 120 shown in FIG. 8A.

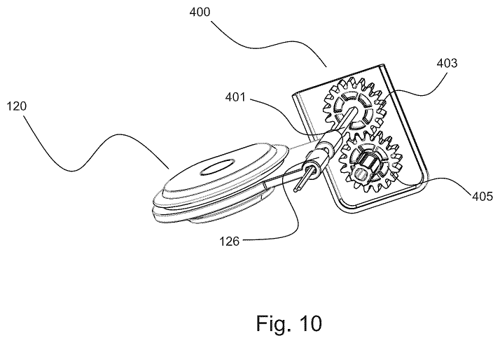

As shown in FIG. 8A, according to an aspect of the present disclosure, the upper housing 301 of the cover device 120 is further provided with a first sealing member 315, and the first sealing member 315 is disposed around the edge of the first mounting portion 311. When the cover device 120 is in the second shielding position as shown in FIG. 2B, the first sealing member 315 forms sealing between the cover device 120 and the second hole 204, so as to protect the AC/DC charging socket in the second hole from external interference such as dust and rain. The cover device 120 further includes a rotating shaft mounting portion 126 for mounting the pivot shaft 400 as shown in FIG. 10.

As shown in FIG. 8B, when the user presses the first contact 333 in the first side actuating portion 330, the cross-shaped protrusion 334 on the other side of the first side pressing portion 332 moves toward and abuts against the trigger portion 351 of the flip trigger device 350, so as to trigger the flip trigger device 350 to generate a trigger signal and transfer the trigger signal to a signal processing unit 500 of the vehicle via a signal transmission portion 353.

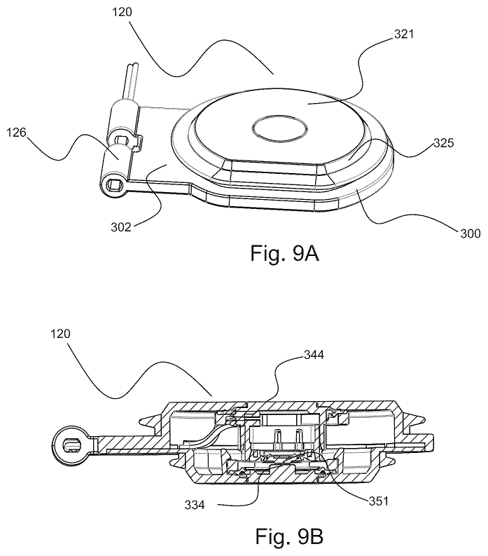

FIG. 9A is a schematic diagram of a structure of the cover device 120 shown in FIG. 2B, and FIG. 9B is a cross-sectional view of the cover device 120 shown in FIG. 9A.

As shown in FIG. 9A, according to an aspect of the present disclosure, the lower housing 302 of the cover device 120 is further provided with a second sealing member 325, and the sealing member 325 is disposed around the edge of the second mounting portion 321. When the cover device 120 is in the first shielding position as shown in FIG. 2A, the second sealing member 325 forms sealing between the cover device 120 and the first hole 203, so as to protect the AC/DC charging socket in the first hole from external interference such as dust and rain. The cover device 120 further includes a rotating shaft mounting portion 126 for mounting the pivot shaft 400 as shown in FIG. 10.

As shown in FIG. 9B, when the user presses the second contact 344 in the mounting bracket 340, the second side pressing portion 342 drives the flip trigger device 350 mounted thereon to move toward the first side pressing portion 332, and the trigger portion 351 on the flip trigger device 350 abuts against the cross-shaped protrusion 334 on the first side pressing portion 332, so as to trigger the flip trigger device 350 to generate a trigger signal and transfer the trigger signal to the signal processing unit 500 of the vehicle via the signal transmission portion 353.

FIG. 10 is a schematic diagram of the cover device 120 according to the present disclosure mounted to a pivot assembly 400.

As shown in FIG. 10, according to an aspect of the present disclosure, the pivot assembly 400 includes a rotating shaft 401 and pivot gears 403, 405. The pivot gears 405 are connected to a drive motor (not shown) by mean of the rotating shaft, the pivot gears 403 and 405 mesh with each other, and the rotating shaft 401 is fixedly mounted to a central shaft thereof. The rotating shaft 401 is inserted into and fixedly mounted in the rotating shaft mounting portion 126 of the cover device 120. When the drive motor receives a drive signal transmitted from the signal processing unit of the vehicle, the drive motor rotates clockwise/counterclockwise by a predetermined angle to drive the pivot gear 405 to rotate by an angle, the pivot gear 405 transfers the rotational force to the rotating shaft 401 via the gear 403, such that the rotating shaft 401 rotates to drive the cover device 120 mounted thereon to rotate around the rotating shaft 401 clockwise/counterclockwise by a predetermined angle, so as to allow the cover device 120 to flip between the first shielding position in which the first opening is shielded and the second shielding position in which the second opening is shielded. Those skilled in the art should understand that the cover device 125 may also be mounted to the drive motor of the vehicle in other forms, as long as the cover device 120 can rotate around the rotating shaft 401 clockwise/counterclockwise.

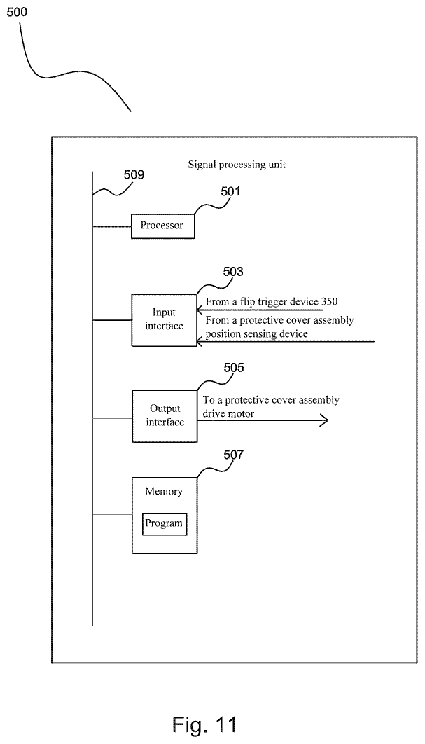

FIG. 11 is a schematic diagram of a structure of a signal processing unit 500 of a vehicle according to the present disclosure.

As shown in FIG. 11, according to an aspect of the present disclosure, the vehicle signal processing unit 500 includes a processor 501, an input interface 503, an output interface 505, and a memory 507 storing programs, which components are communicatively connected to each other through a bus 509. The input interface receives a trigger signal from the flip trigger device 350 in the cover device 120 and a position signal from a protective cover assembly position sensing device (not shown). For example, when the cover device 120 is in the first shielding position shown in FIG. 2A and the user presses the first contact 333 on the first side actuating portion 330, the flip trigger device 350 generates a trigger signal and the protective cover assembly position sensing device (not shown) generates a position signal indicating that the protective cover assembly is in the first shielding position. The trigger signal and the position signal are transferred to the vehicle signal processing unit 500 via the input interface. The processor 501 in the vehicle signal processing unit 500 processes the received trigger signal and position signal based on a preset program stored in the memory 507, and generates a motor drive signal including a rotation direction and a rotation angle. The generated motor drive signal is transferred through the output interface 505 to the protective cover assembly drive motor, and the drive motor rotates by a certain angle in the direction of rotation based on the received drive signal, and enables the cover device 120 to rotate clockwise by approximately 180° from the first shielding position shown in FIG. 2A to the second shielding position shown in FIG. 2B by means of the pivot assembly 400 shown in FIG. 10.

The toggle structure of the vehicle air conditioning vent of the present disclosure has the following advantages.

First, in the prior art, separate protective covers are usually provided on the AC charging port and the DC charging port, respectively, and users can selectively open the protective cover on the AC charging port or the protective cover on the DC charging port so as to allow a charging gun to be inserted into the corresponding charging port. In the present disclosure, the protective cover assembly can be flipped between two charging openings by means of only one cover device, which reduces the cost of the protective cover assembly while achieving the function of charging through one of the charging ports and shielding the other charging port.

Second, the cover device of the present disclosure only includes one flip trigger device for generating both front and back flip trigger signals. Compared with providing two separate flip trigger devices (trigger devices) for respectively pressing from the front and from the back, the cover device of the present disclosure has a lower cost.

Third, in the present disclosure, the cover device is used to solve the problem that no clasp is provided to apply a force when the user needs to manually switch the charging ports, and the switching of the charging ports can be achieved only by pressing the upper and lower pressing portions, which is more convenient for the user to perform a charging operation.

Fourth, the cover device of the present disclosure fully utilizes the space of the dust cover itself during installation, and does not occupy additional space of the charging port assembly, thereby saving more space.

Although the present disclosure is described in conjunction with the examples of aspects outlined above, various alternatives, modifications, variations, improvements, and/or substantial equivalents that are known or current or to be anticipated before long may be obvious to those of at least ordinary skill in the art. In addition, the technical effects and/or technical problems described in the present disclosure are illustrative rather than restrictive. Therefore, the disclosed description in the present disclosure may be used to solve other technical problems and have other technical effects and/or may solve other technical problems. Accordingly, the examples of the aspects of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

What is claimed is:

1. A cover device, which is flippable between a first shielding position and a second shielding position, the cover device comprising:
a housing;
a flip trigger device, the flip trigger device being at least partially accommodated in the housing and having a first side and a second side disposed oppositely, the flip trigger device is configured to generate a flip trigger signal after the first side and the second side are respectively stressed by force, such that the housing is driven to flip between the first shielding position and the second shielding position;
wherein the flip trigger device is configured to remain stationary relative to the housing and be actuated to generate the flip trigger signal when the flip trigger device is stressed by force in a direction from the first side to the second side, and to be movable relative to the housing and be actuated to generate the flip trigger signal when the flip trigger device is stressed by force in a direction from the second side to the first side.

2. The cover device according to claim 1, wherein
the flip trigger device comprises a trigger portion disposed on the first side, the trigger portion is configured to:
be actuated by pressing, when the first side of the flip trigger device is stressed by force, to generate the flip trigger signal; and
move relative to the housing and be actuated by being abutted against, when the second side of the flip trigger device is stressed by force, to generate the flip trigger signal.

3. The cover device according to claim 2, wherein
the cover device further comprises a first side actuating portion, the first side actuating portion is securely connected to the housing and comprises a biasable first side pressing portion, the first side pressing portion being biasable by pressing in the direction from the first side to the second side to contact the trigger portion.

4. The cover device according to claim 3, wherein
the first side actuating portion further comprises a first groove portion, a first groove portion sealing member being provided in the first groove portion.

5. The cover device according to claim 4, wherein
the first groove portion is a U-groove or an O-groove.

6. The cover device according to claim 1, wherein
the cover device further comprises a mounting bracket, the mounting bracket being securely connected to the housing and comprises:
a biasable second side pressing portion, the second side pressing portion being biasable by pressing in the direction from the second side to the first side; and
positioning snap-fitting portions for mounting the flip trigger device, the positioning snap-fitting portions being configured to securely mount the second side pressing portion onto the second side pressing portion, such that the second side pressing portion abuts against the second side of the flip trigger device.

7. The cover device according to claim 6, wherein
the mounting bracket further comprises a second groove portion, a second groove portion sealing member being provided in the second groove portion.

8. The cover device according to claim 7, wherein
the second groove portion is a U-groove or an O-groove.

9. The cover device according to claim 3, wherein
the housing comprises a first mounting portion for mounting the first side actuating portion, an outer side of the first mounting portion comprises a first sealing member disposed around an edge of the first mounting portion, and a central portion of the first mounting portion is provided with a first opening, the first side pressing portion of the first side actuating portion being accessible from the outside of the housing via the first opening.

10. The cover device according to claim 6, wherein
the housing comprises a second mounting portion for mounting the mounting bracket, an outer side of the second mounting portion comprises a second sealing member disposed around an edge of the second mounting portion, and a central portion of the second mounting portion is provided with a second opening, the second side pressing portion of the mounting bracket being accessible from the outside of the housing via the second opening.

11. The cover device according to claim 2, wherein
the flip trigger device further comprises:
a signal transmission portion, the signal transmission portion being configured to transfer the flip trigger signal generated by the trigger portion to a signal processing unit of a vehicle; and
connecting portions, the connecting portions being configured to fit with the positioning portions in the second side pressing portion so as to connect the flip trigger device to the second side pressing portion.

12. A protective assembly for a vehicle charging port, the protective assembly comprising:
a shell mounted on a vehicle body, the shell comprising a first hole and a second hole disposed adjacently;
a cover device of claim 1; and
a cover device mounting portion, the cover device being mounted to the shell via the cover device mounting portion in a flippable manner;
wherein the cover device is configured to be flipped between a first shielding position in which the first hole is shielded and a second shielding position in which the second hole is shielded.
